(19) United States
(12) Patent Application Publication
(10) Pub. No.: US 2010/0218396 A1
(43) Pub. Date: Sep. 2, 2010

(54) METHOD FOR DETERMINING THE SWITCH-OFF MOMENT OF A CARE PROCESS

(75) Inventor: Ulrich Nehring, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/680,913

(22) PCT Filed: Oct. 15, 2008
(86) PCT No.: PCT/EP08/63860

§ 371 Date: Mar. 31, 2010

(30) Foreign Application Priority Data
Oct. 31, 2007 (DE) 10 2007 052 078.8

(51) Int. Cl. F26B 7/00; F26B 19/00

(52) U.S. Cl. 34/427; 34/550

(57) ABSTRACT

A household appliance includes a sensor that senses an electrical resistance of items of laundry, and a controller that defines a course of a total heat energy for the care of the items of laundry, determines an electrical voltage drop based upon the sensed electrical resistance, and determines a switch-off moment of a care process for treating the items of laundry as a function of the course of the total heat energy during the care process, a total of the predefined total heat energy, and the actual value of the electrical voltage of the items of laundry.

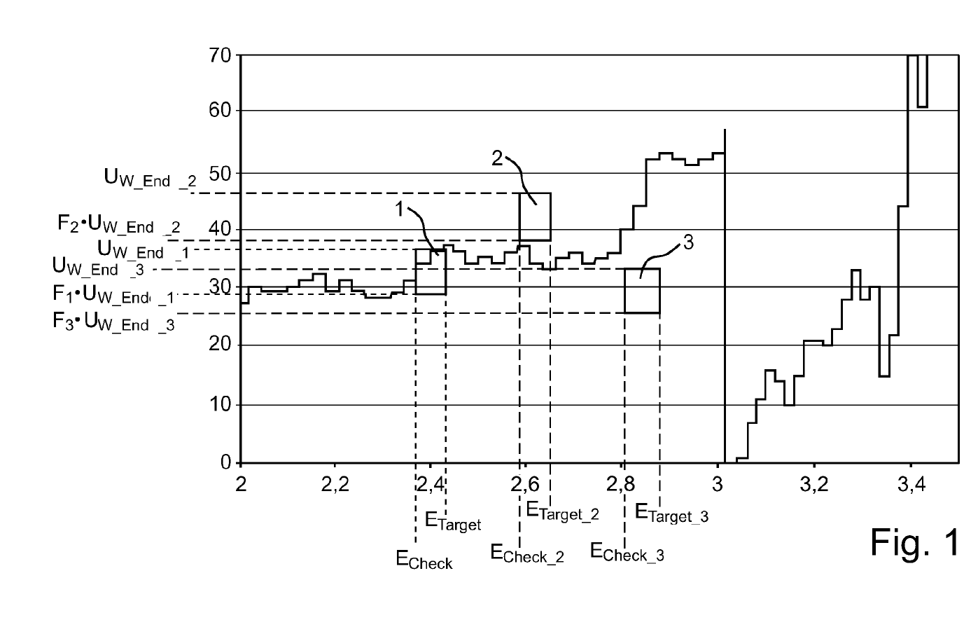

The present invention relates to a method for determining a switch-off moment of a care process for treating items of laundry introduced into a household appliance.

In the present case interest is directed toward determining a switch-off moment of a care process, in particular when a specified final moisture content of the items of laundry is reached. According to a method originating from the Applicant, the residual moisture content of the items of laundry is determined by measuring an electrical resistance of the items of laundry. Reference is made in this regard to documents EP 0 942 094 B1, WO 2004/059072 A1, DE 199 39 274 A1 and DE 44 42 250 C2 which are to be attributed in full respectively to the present disclosure. The transition from carrier electrodes with a large contact area to end plate electrodes with a smaller contact area led to an impairment of the measured signal, however, and therewith to a relatively high scattering of the determined final moisture content.

It is the object of the present invention to propose a method for determining a switch-off moment of a care process, wherein the switch-off moment of the care process can be particularly exactly limited.

This object is achieved according to the invention by a method with the features of one of the independent claims in each case. Preferred developments of the inventive method are the subject matters of corresponding dependent claims or are described hereinafter.

A method according to a first aspect of the invention is designed for determining a switch-off moment of a care process for treating items of laundry introduced into a household appliance. In the method a course of a total heat energy for the care of the items of laundry is predefined and an electrical voltage dropping against an electrical resistance of the items of laundry due to an electrical current of specified strength is determined during the care process, the switch-off moment being determined as a function of the course of the total heat energy during the care process, a total of the predefined total heat energy and the actual value of the electrical voltage of the items of laundry.

A basic idea of the present invention lies in using the information at hand in a processor unit of the household appliance relating to the total heat energy required for the specific care process and the instantaneous laundry voltage dropping against the items of laundry during conduction of an electrical current of specified strength to make a decision on switching-off of the care process. The care process is ended in particular when a specified final moisture content is reached. The evaluation of the voltage dropping at the items of laundry and the total of the required total heat energy advantageously means that a defined load of the household appliance with items of laundry that are to be cared for is recognized and the items of laundry may be purposefully dried.

In the method the total heat energy expended for the entire care process through to a given measuring moment is determined by integrating a heating power over the time during which the care process lasted. If information exists in the microprocessor unit of the household appliance about the course of the heating power, then the total heat energy, which is required for a predefined quantity of items of laundry combined with the initial moisture content, is given or can be determined. The information about the course of the heating power during the drying process and the signal of the laundry voltage are consequently used to make a decision on switching-off of the care process.

In a particularly advantageous development of the method an interval of the total heat energy between a lower first and a higher second total heat energy value and an interval of the voltage of the items of laundry between a lower first and a higher second voltage value are specified, the switch-off moment being determined when the second total heat energy value is reached if an instantaneous value of the voltage during the care process lies within the interval of the voltage and an instantaneous value of the total heat energy within the interval of the total heat energy. In other words, a voltage-energy cluster is thus defined which is limited by the interval of the total heat energy between the first and second total heat energy values on the one hand and by the interval of the voltage across the items of laundry between the first and second voltage values on the other hand. If the voltage dropping at the items of laundry passes through the voltage-energy cluster, the care process is ended at exactly the moment at which the second total heat energy value is reached. This ensures that each time the care process is only ended if the minimal, i.e. the first, voltage value is exceeded.

In the method the switch-off moment is preferably determined for the actual moment at which the voltage value increases above the second voltage value before reaching the first total heat energy value. The care process is therefore ended immediately in the case where the voltage value of the voltage dropping at the items of laundry, determined before reaching the first total heat energy value, has already reached the second higher voltage value. This means that, for example with low load of the household appliance, the care process is not continued unnecessarily once the specified final moisture content has been reached. Electrical energy may thus advantageously be saved.

In the method the switch-off moment is preferably determined for the moment at which the voltage value increases to a threshold value, in particular a value equal to or greater than then second voltage value, if the value of the voltage lies below the first voltage value after reaching the second total heat energy value. In particular the care process is ended if the voltage dropping at the items of laundry has reached the second higher voltage value in the case where the value of the voltage dropping at the items of laundry, determined after reaching the second total heat energy value, is less than the first voltage value. It is thus advantageously ensured that the specified final moisture content of the items of laundry is reached at all times even if the total heat energy required for the care process, in particular the second total heat energy value, has already been exceeded.

The first voltage value is preferably specified by multiplying the second voltage value by a factor less than 1, the factor preferably being defined in a development phase of the household appliance as a function of the drying program. The laundry voltage corresponding to a specified final moisture content of the items of laundry can be exactly determined in particular in the development phase and, more precisely, as a function of the drying program. For determining the factor, and therefore the voltage interval, parameters such as load, ambient temperature, initial moisture content of the items of laundry and the like are used in particular.

According to a further aspect the present invention relates to a method for determining a switch-off moment of a care process for treating items of laundry introduced into a household appliance. In this inventive method a process time of the selected care process for the care of the items of laundry is predefined and an electrical voltage dropping at an electrical resistance of the items of laundry is determined during the care process, the switch-off moment being determined as a function of the advanced process time during the care process, the predefined process time of the selected care process and the actual value of the electrical voltage of the items of laundry. The process time, which is also available in the microprocessor unit of the household appliance, is therefore used instead of the total heat energy to determine the switch-off moment of the care process.

In particular, both variables, namely the total heat energy and the process time, can be regarded as equal. The inventive method advantageously means that both the instantaneous voltage dropping at the items of laundry and the required process time are taken into account when determining the switch-off moment of the care process. In particular the care process is ended when a specified final moisture content of the items of laundry is reached.

In the method a process time interval between a first and a higher second moment and an interval of the voltage of the items of laundry between a first and a higher second voltage value are specified, the switch-off moment being determined when the second moment is reached if an instantaneous value of the voltage during the care process lies within the interval of the voltage and an instantaneous moment of the process time within the process time interval. A time-voltage cluster is therefore defined which is limited by the interval of the laundry voltage between the first and the second values of the voltage on the one hand and by the interval between the first and second moments on the other hand. This ensures that the specified final moisture content or level of dryness of the items of laundry is always reached.

In the method the switch-off moment is preferably determined for the instantaneous moment at which the instantaneous value of the voltage of the laundry items increases to the second voltage value before reaching the first moment. In other words, the care process is then ended immediately at this instantaneous moment. Electrical energy can advantageously be saved thereby because, for example with lower loading of the household appliance, the care process is ended as soon as the specified final moisture content is reached, without the predetermined first or second moment having to be reached.

In the method the switch-off moment is preferably determined for the instant at which the value of the voltage increases to a threshold value, in particular a value equal to or greater than the second voltage value, if the value of the voltage lies below the first voltage value after reaching the second moment. This means that the specified final moisture content of the items of laundry is reached every time, even if the predefined process time is exceeded.

In the method the first voltage value is preferably specified by multiplying the second voltage value by a factor less than 1, the factor preferably being defined in a development phase of the household appliance as a function of the drying program. The factor, and therefore the first and second voltage values, can be determined particularly exactly thereby, in particular on the basis of parameters such as load, ambient temperature, initial moisture content of the items of laundry and the like.

Further advantages, features and details of the invention emerge from the following description of a preferred exemplary embodiment and with reference to the drawing.

The single FIGURE shows an exemplary course of a laundry voltage dropping at items of laundry introduced into a household appliance over a total heat energy required for a predefined quantity of items of laundry including their initial moisture content.

The household appliance for caring for items of laundry can be a dryer or a washer-dryer, comprising a control unit that is set up, in particular programmed, to carry out the method to be described hereinafter and that is connected to appropriate sensors for measuring the necessary data to carry out the method.

According to an exemplary embodiment of a method for determining a switch-off moment of a care process for treating items of laundry introduced into a household appliance, first and second values of a laundry voltage dropping at the items of laundry are defined. The first value of the laundry voltage F·U_{W}_{_{—}}_{End} is produced by multiplying the second value of the laundry voltage U_{W}_{_{—}}_{End} by a factor less than 1. The two values of the laundry voltage are shown in the graph illustrated in the FIGURE. Furthermore, according to the exemplary embodiment information about the course of a heating power exists and, more precisely, as a function of the selected drying program. Integrating the course of the heating power produces a total of the total heat energy E_{Target} that is required for the care process for the pre-selected drying program and for a predefined quantity of items of laundry including initial moisture content. Furthermore, a minimal total heat energy E_{check} is specified which has already been determined within a development phase of the household appliance for each drying program, each load, ambient temperature and initial moisture content. The two values of the total heat energy E_{check} and E_{Target} are plotted on the graph.

An energy-voltage cluster 1 is formed by fixing the two values of the laundry voltage U_{W}_{_{—}}_{End} and F·U_{W}_{_{—}}_{End} and the two values of the total heat energy E_{check} and E_{Target}. An exemplary position of the energy-voltage cluster 1 is shown in the figure, the position of the energy-voltage cluster 1 being dependent on the selected drying program and the above-stated parameters.

According to the exemplary embodiment the care process is ended once a specified final moisture content of the items of laundry is reached. As may be seen from the figure, the laundry voltage runs within the energy-voltage cluster 1. In this case the care process is ended at the moment at which the total heat energy E_{Target} is reached.

If a different drying program is selected or a different quantity of items of laundry is detected, a different energy-voltage cluster 2, for example, is defined, as may be seen from the graph. The energy-voltage cluster 2 is based on the following values of laundry voltage and total heat energy: U_{W}_{_{—}}_{End}_{_{—}}₂, F·U_{W}_{_{—}}_{End}_{_{—}}₂ and E_{Check}_{_{—}}₂ and E_{Target}_{_{—}}₂. It can be seen from the FIGURE that the laundry voltage now runs outside of the energy-voltage cluster. According to the exemplary embodiment the care process is therefore ended if the laundry voltage has reached the maximum value U_{W}_{_{—}}_{End}_{_{—}}₂.

A further energy-voltage cluster 3 is defined for a further drying program by the total heat energies E_{Check}_{_{—}}₃ and E_{Target}_{_{—}}₃ and by the laundry voltages U_{W}_{_{—W}}_{_{—}}_{End}_{_{—}}₃ and F·U_{W}_{_{—}}_{End}_{_{—}}₃. It can be seen from the graph that the laundry voltage has reached the maximum laundry voltage U_{W}_{_{—}}_{End}_{_{—}}₃ even before reaching the total heat energy E_{Check}_{_{—}}₃. In this case the care process is ended prematurely and, more precisely, directly after reaching the maximum laundry voltage U_{W}_{_{—}}_{End}_{_{—}}₃. This avoids the care process being continued unnecessarily in the case where the specified final moisture content of the items of laundry has already been reached.

Instead of the total heat energy introduced in the graph, a process time, which also exists, may also be used. A first process time t_{Check} can therefore be defined instead of the first total heat energy E_{Check} and a second process time t_{Target} can be defined instead of the second total heat energy E_{Target}. Both variables, the total heat energy and the process time, can be regarded as equal. When only one of the two variables is given, the statement can also be transferred to the second variable.

1-13. (canceled)

14. A household appliance comprising:
a sensor that senses an electrical resistance of items of laundry; and
a controller that defines a course of a total heat energy for the care of the items of laundry, determines an electrical voltage drop based upon the sensed electrical resistance, and determines a switch-off moment of a care process for treating the items of laundry as a function of the course of the total heat energy during the care process, a total of the predefined total heat energy, and the actual value of the electrical voltage of the items of laundry.

15. A method for determining a switch-off moment of a care process for treating items of laundry introduced into a household appliance, the method comprising:
defining a course of a total heat energy for the care of the items of laundry;
determining an electrical voltage drop against an electrical resistance of the items of laundry due to an electrical current of specified strength during the care process; and
determining the switch-off moment as a function of the course of the total heat energy during the care process, a total of the predefined total heat energy, and the actual value of the electrical voltage of the items of laundry.

16. The method of claim 15, further comprising determining a total heat energy for an entire care process by integrating a heating power.

17. The method of claim 15, further comprising specifying an interval of a total heat energy between a first total heat energy value and a higher second total heat energy value and an interval of the voltage of the items of laundry between a first voltage value and a higher second voltage value, wherein said determining of the switch-off moment comprises determining the switch-off moment when the second total heat energy value is reached if an instantaneous value of the voltage during the care process lies within the interval of the voltage and an instantaneous value of the total heat energy within the interval of the total heat energy.

18. The method of claim 17, further comprising specifying the first voltage value by multiplying the second voltage value by a factor less than 1.

19. The method of claim 18, further comprising defining the factor in a development phase of the household appliance as a function of a drying program.

20. The method of claim 15, further comprising specifying an interval of the total heat energy between a first total heat energy value and a higher second total heat energy value and an interval of the voltage of the items of laundry between a first voltage value and a higher second voltage value, wherein said determining of the switch-off moment comprises determining the switch-off moment for the actual moment at which the voltage value increases above the second voltage value before reaching the first total heat energy value.

21. The method of claim 15, further comprising specifying an interval of the total heat energy between a first total heat energy value and a higher second total heat energy value and an interval of the voltage of the items of laundry between a first voltage value and a higher second voltage value, wherein said determining of the switch-off moment comprises determining the switch-off moment for the moment at which the voltage value increases to a threshold value of a value equal to or greater than the second voltage value, if the value of the voltage lies below the first voltage value after reaching the second total heat energy value.

22. A method for determining a switch-off moment of a care process for treating items of laundry introduced into a household appliance, the method comprising:
defining a process time of the selected care process for the care of the items of laundry;
determining an electrical voltage dropping against an electrical resistance of the items of laundry due to an electrical current of specified strength at an electrical resistance of the items of laundry during the care process; and
determining the switch-off moment as a function of an advanced process time during the care process, the process time of the selected care process, and the actual value of the electrical voltage of the items of laundry.

23. The method of claim 22, further comprising specifying a process time interval between a first moment and a higher second moment and an interval of the voltage of the items of laundry between a first voltage value and a higher second voltage value, wherein the determining of the switch-off moment comprises determining the switch-off moment when the second value of the process time is reached if an instantaneous value of the voltage during the care process lies within the interval of the voltage and an instantaneous moment of the process time during the process time interval.

24. The method of claim 23, further comprising specifying the first voltage value by multiplying the second voltage value by a factor less than 1.

25. The method of claim 24, further comprising determining the factor in a development phase of the household appliance as a function of the drying program.

26. The method of claim 22, further comprising specifying a process time interval between a first moment and a higher second moment and an interval of the voltage of the items of laundry between a first voltage value and a higher second voltage value, wherein the determining of the switch-off moment comprises determining the switch-off moment for the instantaneous moment at which the instantaneous voltage value increases to the second voltage value before reaching the first moment.

27. The method of claim 22, further comprising specifying a process time interval between a first moment and a higher second moment and an interval of the voltage of the items of laundry between a first voltage value and a higher second voltage value, wherein the determining of the switch-off moment comprises determining the switch-off moment for the moment at which the value of the voltage increases to a value equal to or greater than the second voltage value, if the value of the voltage lies below the first voltage value after reaching the second moment.
